(19) United States
(12) Patent Application Publication
(10) Pub. No.: US 2008/0157486 A1
(43) Pub. Date: Jul. 3, 2008

(54) RUBBER/RESIN COMPOSITE SEAL MATERIAL

(75) Inventors: Naoya Kuzawa, Hamamatsu-shi (JP); Hideyuki Shishitani, Hamamatsu-shi (JP)

Correspondence Address: NIXON & VANDERHYE, PC, 901 NORTH GLEBE ROAD, 11TH FLOOR, ARLINGTON, VA, 22203, US

(73) Assignee: NICHIAS CORPORATION, TOKYO (JP)

(21) Appl. No.: 12/003,638

(22) Filed: Dec. 28, 2007

(30) Foreign Application Priority Data
Dec. 28, 2006 (JP) 2006-355039

(51) Int. Cl. F16J 15/00

(52) U.S. Cl. 277/650

(57) ABSTRACT

The present invention provides a rubber/resin composite seal material comprising: a base material comprising a rubbery elastomer; and a fluororesin film bonded to the base material with an adhesive.

### FIELD OF THE INVENTION

The present invention relates to a seal material used in a site required to have plasma resistance, chemical resistance, heat resistance or the like.

### BACKGROUND OF THE INVENTION

Seal materials employed in equipment used under circumstances such as a plasma atmosphere and a chemical atmosphere are required to have high stability to various chemical species, and molded articles made of a fluoroelastomer are mainly used. In such equipment, gases or chemical solutions having high concentration and high chemical reactivity have recently become to be used for the reason of promoting the efficiency, or the like. Accordingly, the seal materials made of the fluoroelastomer which have hitherto been widely used are heavily deteriorated, so that it has become necessary to early exchange them.

Of the fluoroelastomers, perfluoroelastomers show particularly excellent plasma resistance and chemical resistance, so that they have been in heavy usage as seal materials for the equipment used under the above-mentioned severe circumstances. However, the perfluoroelastomers have a problem of being extremely expensive.

On the other hand, to such a situation, there have been proposed composite type seal materials in which a seal member made of a fluororesin having high plasma resistance is arranged on a plasma contact surface and a seal member made of a fluoroelastomer is arranged on a plasma non-contact portion (for example, see patent documents 1 and 2).

Patent Document 1: JP-A-2005-164027

Patent Document 2: WO 2004/038781

However, in each of the composite type seal materials described in the above-mentioned patent documents 1 and 2, the seal member made of the fluororesin is only for the purpose of preventing plasma from entering the fluoroelastomer seal member side. Strictly speaking, this seal member made of the fluororesin dose not exhibit seal performance. Accordingly, even when the seal member made of the fluororesin is slightly deformed, plasma is likely to enter the fluoroelastomer seal member side. Further, the fluororesin has the properties of being easily deformed by heat compression and being difficult to be restored to the original state, so that when the seal material is used for a long period of time under a heated atmosphere or under an environment where it is repeatedly compressed, the possibility for plasma to enter the fluoroelastomer seal member side becomes high.

### SUMMARY OF THE INVENTION

The invention has been made in view of such a situation, and an object thereof is to provide a seal material which exhibits plasma resistance, chemical resistance and sealing properties, particularly excellent plasma resistance even when used for a long period of time under a heated atmosphere or under an environment where it is repeatedly compressed.

Other objects and effects of the invention will become apparent from the following description.

In order to solve the above-mentioned problems, the present inventors have conducted intensive studies. As a result, it has been found that a seal material which exhibits plasma resistance, chemical resistance and sealing properties, particularly excellent plasma resistance even when used for a long period of time under a heated atmosphere or under an environment where it is repeatedly compressed is obtained by bonding a base material comprising a rubbery elastomer to a fluororesin film with an adhesive.

That is, the invention provides the following rubber/resin composite seal material:

(1) A rubber/resin composite seal material comprising: a base material comprising a rubbery elastomer; and a fluororesin film bonded to the base material with an adhesive;

(2) The rubber/resin composite seal material described in the above (1), wherein the fluororesin film has a thickness of 50 μm or less;

(3) The rubber/resin composite seal material described in the above (1) or (2), wherein at least a portion which comes into contact with a fluid to be sealed is covered with the fluororesin film; and

(4) The rubber/resin composite seal material described in any one of the above (1) to (3), wherein the fluororesin film comprises polytetrafluoroethylene, a tetrafluoroethylene-hexafluoropropylene copolymer, a tetrafluoroethylene-perfluoroalkyl vinyl ether copolymer or a mixture thereof.

According to the rubber/resin composite seal material of the invention, the fluororesin excellent in plasma resistance and the like is formed into film shape, and bonded to the base material comprising the rubbery elastomer. Accordingly, plasma resistance and chemical resistance are imparted thereto while securing and maintaining sealing properties due to the base material comprising the rubbery elastomer. In particular, the rubber/resin composite seal material exhibits excellent plasma resistance even when used for a long period of time under a heated atmosphere or under an environment where it is repeatedly compressed.

### BRIEF DESCRIPTION OF THE DRAWINGS

FIG. 1 is a schematic view showing a state in which an O-ring comprising a rubber/resin composite seal material of the present invention is mounted on a sealing portion.

FIGS. 2(A) to 2(C) are schematic views showing a process for preparing an O-ring, an example of a rubber/resin composite seal material of the invention.

FIG. 3 is a cross sectional view showing a rubber/resin composite seal material (O-ring) obtained by the process shown in FIGS. 2(A) to 2(C).

FIG. 4 is a cross sectional view showing a mold used for preparing a seal material of Comparative Example 2.

FIG. 5 is a cross sectional view showing the seal material of Comparative Example 2.

FIG. 6 is a schematic view for illustrating a test method of a plasma exposure test.

FIG. 7 is a schematic view for illustrating a test method of a helium leak test.

The reference numerals used in the drawings denote the following, respectively.
1: Rubbery Elastomer
10: Fluororesin Film

### DETAILED DESCRIPTION OF THE INVENTION

The best mode for carrying out of the invention (hereinafter referred to as an embodiment) will be described below.

The rubber/resin composite seal material of the invention is one prepared by bonding a base material comprising a rubbery elastomer to a fluororesin film with an adhesive.

The rubbery elastomer as used herein means a crosslinked rubber composition. Examples of rubber materials which can be used include but are not limited to natural rubber, isoprene rubber, butadiene rubber, styrene-butadiene rubber, butyl rubber, chloroprene rubber, nitrile rubber, ethylene-propylene rubber, acryl rubber, epichlorohydrin rubber, Hypalon, urethane rubber, silicone rubber, fluororubber, perfluororubber and the like. Considering that they are used under a heated atmosphere or under an environment where repeatedly compressed, ethylene-propylene rubber and fluororubber are desirable. The crosslinking method is not particularly limited.

From the viewpoints of plasma resistance, chemical resistance and heat resistance, the fluororesin is desirably polytetrafluoroethylene, a tetrafluoroethylene-hexafluoropropylene copolymer and a tetrafluoroethylene-perfluoroalkyl vinyl ether copolymer, but are not limited thereto. Further, they can be used as a mixture thereof. However, depending on the situation, other fluororesins may be used, not limited only to the above-mentioned fluororesins.

In order to secure sealing properties by the base material comprising the rubbery elastomer and plasma resistance, the thickness of the fluororesin film is desirably 50 μm or less, and more desirably from 1 to 40 μm.

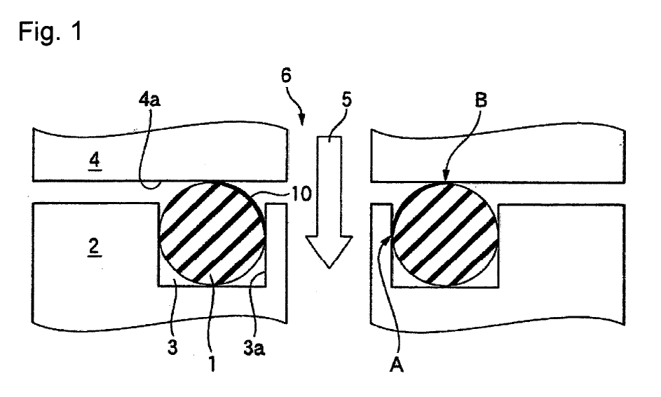

The fluororesin film is preferably bonded so as to cover the whole surface of the base material comprising the rubbery elastomer. However, it may be bonded so as to cover only a portion which comes into contact with a fluid to be sealed in the site where the seal material is mounted. The above-mentioned portion which comes into contact with a fluid to be sealed also includes a sealing surface which is a contact surface with a flange or the like, as well as the contact portion with the fluid. FIG. 1 is a schematic view showing a state in which an O-ring comprising the rubber/resin composite seal material is mounted on a sealing portion. The O-ring 1 is housed in a circular ring-shaped groove 3 of a first member 2, and a second member 4 is placed thereon. The first member 2 and the second member 4 are clamped in the vertical direction in the drawing, thereby sealing a joint portion of both members. The fluid (gas or liquid) 5 flows through a flow path 6 provided along a central axis of the first member 2 and the second member 4, so that a fluororesin film 10 is only required to be bonded so as to cover the surface of the O-ring 1 from a contact portion A with an inner peripheral surface 3a of the groove 3 of the first member 2 to a contact portion B with a bottom surface 4a of the second member 4, that is, so as to cover at least one-fourth of an arc surface of the O-ring 1 on the flow path side in cross section.

In order to bond the base material comprising the rubbery elastomer to the fluororesin film, the adhesive is used. The adhesive is not limited, as long as it can bond the rubbery elastomer to the fluororesin film, and is appropriately selected depending on the kinds of the rubbery elastomer and the fluororesin.

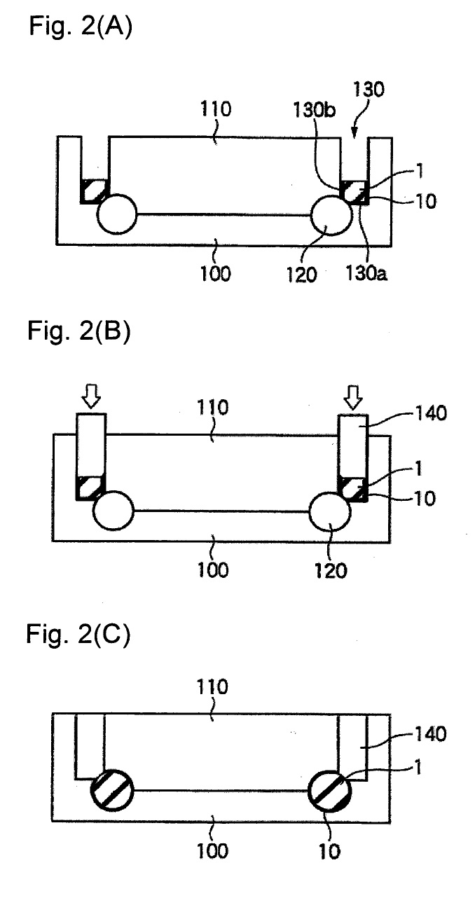

The rubber/resin composite seal material of the invention can be prepared, for example, by a molding process shown in FIG. 2. The case of preparing an O-ring is exemplified herein. For molding, an outer frame mold 100, and an inner frame mold 110 arranged concentrically with the outer frame mold 100 are used. Both molds 100 and 110 have a shape of forming a circular ring-shaped, cross-sectionally circular empty space 120 and a circular ring-shaped clearance 130 continuing from a part of the outer peripheral side of the empty space 120, as shown in FIG. 2(A). First, as shown in FIG. 2(A), the fluororesin film 10, which is coated with an adhesive on its surface that has been subjected to cementable treatment, is disposed with giving a concave shape in cross section so as to cover a bottom surface 130a of the clearance 130 between the outer frame mold 100 and the inner frame mold 110 and a lower portion of an inner peripheral surface 130b thereof, and further, the rubbery material 1 having a rectangular cross section is placed on the fluororesin film 10. The area of the fluororesin film 10 is adjusted to such a size that approximately the whole surface of an inner wall of the empty space 120 can be covered, and the volume of the rubbery material 1 is adjusted to approximately the same as the inner volume of the empty space 120. Then, as shown in FIG. 2(B), a circular ring-shaped pushing member 140 is inserted into the clearance 130 between the outer frame mold 100 and the inner frame mold 110, and pushed downward in the drawing. Thereby, the inner wall of the empty space 120 is covered with the fluororesin film 10 except for the portion communicating to the clearance 130, and the inside of the fluororesin film 10 is filled with the rubbery material 1, as shown in FIG. 2(C). Then, the fluororesin film 10 is strongly bonded to the rubbery elastomer 1 with the adhesive by heating in this state. Further, secondary crosslinking of the rubbery material may be performed as needed.

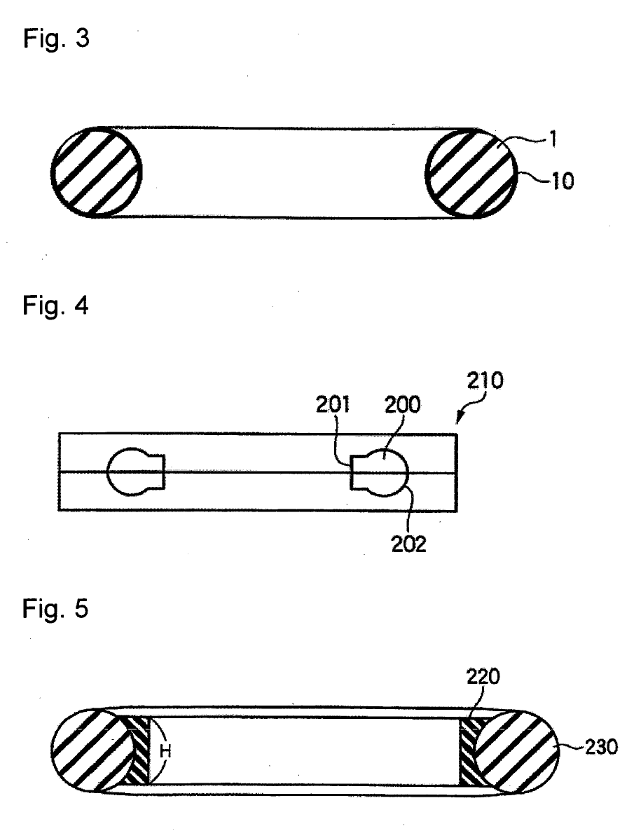

FIG. 3 is a cross sectional view schematically showing the O-ring thus obtained. As shown in FIG. 1, the portion which comes into contact with a fluid is covered with the fluororesin film 10.

### EXAMPLES

The present invention will be illustrated in greater detail with reference to the following examples and comparative examples, but the invention should not be construed as being limited thereto.

### Example 1

As a rubbery elastomer, Fluororubber DC2280 manufactured by Daikin Industries, Ltd. was used. As a fluororesin film, a 20-μm thick PTFE film subjected to cementable treatment was used. As an adhesive, Chemlok 5150 manufactured by Lord Far East Inc. was used. According to the process shown in FIG. 2, an O-ring (AS568-214 size) covered with a PTFE film as shown in FIG. 3 was prepared. Molding was made at 170° C. for 10 minutes, and heating was performed at 230° C. for 24 hours to conduct secondary curing.

### Example 2

An O-ring was prepared in the same manner as in Example 1 with the exception that a 40-μm thick PTFE film was used.

### Comparative Example 1

An O-ring was prepared in the same manner as in Example 1 with the exception that a 100-μm thick PTFE film was used.

### Comparative Example 2

Using a pair of upper and lower molds 210 having a circular ring-shaped empty space 200 shaped so that it was rectangular on the internal diameter side and circular on the outer side thereof in cross section, as shown in FIG. 4, a seal material was prepared. As shown in FIG. 5, a PTFE block 220 rectangular in cross section and having an arc concave portion formed on the outer peripheral side thereof and further subjected to cementable treatment was arranged in a rectangular portion 201 of the empty space 200, and an O-ring 230 comprising Fluororubber DC2280 manufactured by Daikin Industries, Ltd. was arranged in a circular portion 202, followed by molding. The height H of the PTFE block 220 was 0.75 times the diameter of the O-ring 230. As an adhesive, Chemlok 5150 manufactured by Lord Far East Inc. was used. Molding was made at 170° C. for 10 minutes, and then, heating was performed at 230° C. for 24 hours to conduct secondary curing. In the resulting seal material, the O-ring 230 comprising the fluororubber was bonded to the outer side of the PTFE block 220 as shown in FIG. 5, and the size thereof was approximately AS568-214 size.

### Comparative Example 3

Using Fluororubber DC2280 manufactured by Daikin Industries, Ltd., an AS568-214 size O-ring (having no fluororesin film) was prepared. Molding was made at 170° C. for 10 minutes, and then, heating was performed at 230° C. for 24 hours to conduct secondary curing.

The O-rings or seal materials prepared above were subjected to (1) a plasma exposure test, (2) a helium leak test and (3) a plasma exposure test after heat compression, the results of which are shown below.

### (1) Plasma Exposure Test

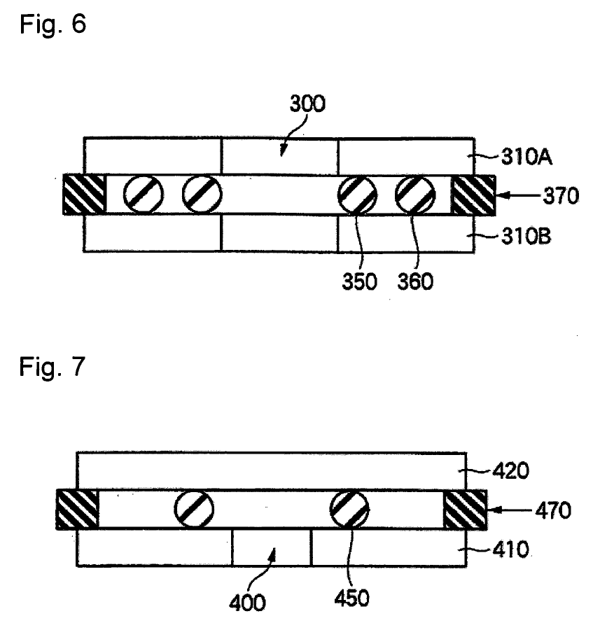

As schematically shown in FIG. 6, an O-ring or seal material 350 was placed between two flanges 310A and 310B provided at a center portion thereof with a through hole 300 for allowing plasma to pass through, and an AS568-223 size perfluororubber seal O-ring 360 for preventing plasma from entering from the outer diameter side to the O-ring or seal material 350 was placed on the outer side thereof. Further, a spacer 370 having a thickness of 0.75 times the height of the O-ring or seal material 350 under an atmosphere of 25° C. was placed on the outer side thereof (flange ends), and the whole was clamped to the thickness of the spacer 370. Then, it was placed in a plasma etching apparatus together with the flanges, and exposed to plasma under the following conditions. The rate of decrease in weight was calculated from the difference in weight of the O-ring or seal material 350 between before and after plasma exposure.

### <Plasma Exposure Conditions>

Plasma generating apparatus: Surface wave plasma etching apparatus manufactured by Shinko Seiki Co., Ltd.;

Sample size: A5568-214;

Etching gas: O₂/CF₄ (2000/200 ml/min);

Processing pressure: 100 Pa;

Power consumption: 3000 W;

Plasma exposure time: 2 hours; and

The rate of decrease in weight (% by weight): [(Sample weight before exposure to plasma−sample weight after exposure to plasma)/(sample weight before exposure to plasma)]×100.

### (2) Helium Leak Test

As schematically shown in FIG. 7, an O-ring or seal material 450 was placed between a lower flange 410 provided with a helium inflow opening 400 and an upper flange 420 having no opening, and a spacer 470 having a thickness of 0.75 times the height of the O-ring or seal material 450 under an atmosphere of 25° C. was placed on the outer side thereof (flange ends). The whole was clamped to the thickness of the spacer 470. Then, it was mounted on a Helium leak detector UL500 manufactured by LEYBOLD together with the flanges, and helium gas was introduced into the outside of the O-ring or seal material 450. After an elapse of 10 minutes, the amount of helium which leaked in the inside of the O-ring or seal material 450 was measured.

(3) Plasma Exposure Test after Heat Compression

Flanges clamped in the same manner as in the plasma exposure test described in the above (1) was placed in an oven heated to 200° C., and kept for 72 hours. Then, the flanges were taken out from the oven, and a plasma exposure test was made under the same conditions as described above. The rate of decrease in weight was calculated from the difference in weight of the O-ring or seal material between before and after plasma exposure.

TABLE 1

| | | | Compara. | Compara. | Compara. |
|---|---|---|---|---|---|
| | Example 1 | Example 2 | Example 1 | Example 2 | Example 3 |
| PTFE Film Thickness (μm) | 20 | 40 | 100 | Block | Not used |
| Plasma Exposure Test (wt %) | 0.03 | 0.02 | 0.03 | 0.04 | 0.05 |
| Helium Leak Test (Pa · m³/sec) | 8.2E−10 | 9.1E−10 | 3.4E−6 | 3.9E−10 | 3.1E−10 |
| Plasma Exposure Test after | 0.19 | 0.17 | 0.17 | 0.41 | 0.94 |
| Heat Compression (wt %) | | | | | |

As shown in Table 1 described above, both the O-rings of Examples 1 and 2 according to the invention are small in the rate of decrease in weight by the plasma exposure test, and also in the helium leak test, a leak is rarely observed. Further, also in the plasma test after heat compression, the rate of decrease in weight does not change.

On the other hand, the O-ring of Comparative Example 1 is small in the rate of decrease in weight by the plasma exposure test, but extremely large in the leak amount by the helium leak test. Further, the seal material of Comparative Example 2 is small in both the rate of decrease in weight by the initial plasma exposure test and the leak amount by the helium leak test, but the rate of decrease in weight significantly increases in the plasma exposure test after heat compression. Furthermore, the O-ring of Comparative Example 3 is extremely large in the rate of decrease in weight by the plasma exposure test, because it is covered with no PTFE film.

While the present invention has been described in detail and with reference to specific embodiments thereof, it will be apparent to one skilled in the art that various changes and modifications can be made therein without departing from the spirit and scope thereof.

This application is based on Japanese Patent Application No. 2006-355039 filed on Dec. 28, 2006, and the contents thereof are herein incorporated by reference.

What is claimed is:

1. A rubber/resin composite seal material comprising:
a base material comprising a rubbery elastomer; and
a fluororesin film bonded to the base material with an adhesive.

2. The rubber/resin composite seal material according to claim 1, wherein the fluororesin film has a thickness of 50 μm or less.

3. The rubber/resin composite seal material according to claim 1, wherein at least a portion which comes into contact with a fluid to be sealed is covered with the fluororesin film.

4. The rubber/resin composite seal material according to claim 1, wherein the fluororesin film comprises polytetrafluoroethylene, a tetrafluoroethylene-hexafluoropropylene copolymer, a tetrafluoroethylene-perfluoroalkyl vinyl ether copolymer or a mixture thereof.
